(19) United States
(12) Patent Application Publication
(10) Pub. No.: US 2025/0268150 A1
(43) Pub. Date: Aug. 28, 2025

(54) LANDSCAPING APPARATUS

(71) Applicant: EMAK S.P.A., BAGNOLO IN PIANO (RE) (IT)

(72) Inventor: Gianluca BARBOLINI, MODENA (IT)

(21) Appl. No.: 18/857,901

(22) PCT Filed: Apr. 7, 2023
(86) PCT No.: PCT/IB2023/053577

§ 371 Date: Oct. 18, 2024

(30) Foreign Application Priority Data
Apr. 20, 2022 (IT) 102022000007799

(51) Int. Cl. A01G 3/08; A01D 34/00; A01D 101/00; A01G 3/04; H04B 1/3827

(52) U.S. Cl. CPC A01G 3/086; A01G 3/04; A01D 34/006; A01D 2101/00; H04B 1/3827

(57) ABSTRACT

The present invention relates to a landscaping apparatus (1) comprising: a landscaping tool (10) of the motor-driven type, provided with an electronic control and command unit (40), a portable remote device (60), a first wireless transceiver (45) operatively connected to the electronic control and command unit (40) of the landscaping tool, and a second wireless transceiver (50) associated with the portable remote device (60). The electronic control and command unit (40) is configured to cyclically measure a value indicative of a distance between the tool and the portable remote device by processing signals exchanged between the first wireless transceiver and the second wireless transceiver, and cyclically compares said value indicative of the measured distance with a predetermined value indicative of a maximum distance so as to automatically bring or keep the tool in an inactive condition when said value indicative of the measured distance is greater than said reference value and/or when it is not possible to measure the value indicative of the measured with international search report (Art. 21(3))

### TECHNICAL FIELD

The present invention relates to a landscaping apparatus provided with a landscaping tool, such as chainsaws, brush cutters, hedge trimmers, blowers, lawnmowers, etc.

### PRIOR ART

It is known that gardening tools may be inherently dangerous to the health of people using them, and/or of those who are in the nearby area, due to possible cutting injuries and/or skin burns, particularly in the case of tools with cutting elements such as chainsaws, brush cutters, hedge trimmers, and lawnmowers.

This danger is particularly emphasized in case a child tinkers with the tool without adult supervision and control. In this respect, new generation electrically-powered landscaping tools are even easier for a child to start, by only pushing a button, thus making them even more dangerous than those with an endothermic motor, which require a rope to be pulled with some force to be started.

The object of the present invention is to overcome the constraints of the prior art in the context of an efficient, rational and cost-effective solution.

Such an object is achieved by the features of the invention reported in the independent claim. The dependent claims outline preferred and/or particularly advantageous aspects of the invention.

### DISCLOSURE OF THE INVENTION

In particular the invention makes available a landscaping apparatus comprising:
a motor-driven landscaping tool provided with an electronic control and command unit,
a portable remote device,
a first wireless transceiver operationally connected to the electronic control and command unit of the landscaping tool,
a second wireless transceiver associated with the remote device,
   wherein the electronic control and command unit is configured to cyclically measure a value indicative of a distance between the tool and the remote device by processing signals exchanged between the first wireless transceiver and the second wireless transceiver,
   and wherein the electronic control and command unit is configured to cyclically compare said value indicative of the measured distance with a predetermined value indicative of a maximum distance and to automatically bring or keep the tool in an inactive condition when said value indicative of the measured distance is higher than said reference value and/or when it is not possible to measure the value indicative of the measured distance. It is thereby made available a gardening tool that is safer than those of the prior art, since if the portable remote device is at a distance greater than the preset value of maximum distance it automatically switches into an inactive condition, wherein the movable working element is not actuated and is therefore not dangerous. Therefore, the user only needs to wear or carry the portable remote device in his or her pocket to prevent it from being used by third parties in an incorrect and/or unsupervised manner. In addition, such configuration allows the tool to be automatically switched off in case it falls from the hands of an operator who is operating at a certain height above the ground, thus limiting damage to the tool and to what is impacted by the tool during the fall. Such a situation is, for example, that of an operator equipped with a chainsaw or hedge trimmer working on a ladder, on a scaffold, on a basket or on a tree.

For example, the predetermined value indicative of the maximum distance may be equal to a maximum distance of 10 m.

Regardless of the exact value, the predetermined value indicative of the maximum distance is less than a maximum range, in terms of distance, of each transceiver.

According to another aspect of the invention, the electronic control and command unit of the tool may also be configured to automatically bring or keep the landscaping tool in an active condition when the value indicative of the measured distance is lower than the predetermined value indicative of the maximum distance.

Thereby, when the user is within the range of the maximum distance beyond which the tool is automatically de-activated, the electronic control and command unit automatically re-activates the tool, thus making operations particularly smooth without hindering the user's job.

According to yet another aspect of the invention, the electronic control and command unit of the tool may also be configured to automatically bring or keep the landscaping tool in an active condition when the value indicative of the measured distance is lower than the predetermined value indicative of the maximum distance, if, within a predetermined time interval from a time of measurement of the parameter indicative of the distance, the electronic control and command unit receives a predetermined authorization signal containing a specific identification code sent by the portable remote device via the second wireless transceiver.

It is thereby possible to increase safety and also reduce thefts, as, in order to switch on the tool, the predetermined specific activation signal must be received, thereby making the tool useless in case it is stolen. The identification code ensures that having a compatible remote device is not enough to be able to switch on the tool, but the remote device must be a specific one, whose identity might be associated with the electronic control and command unit of the tool during a coupling step between the remote device and the tool.

According to a further aspect of the invention, the electronic control and command unit may be configured to perform a learning step during which, for a predetermined learning time interval the electronic control and command unit cyclically monitors the value indicative of the distance between the tool and the remote device, stores the detected values in a memory unit and on the basis of the stored values indicative of the distance during the learning time interval defines an operating range of values indicative of the distance,

and wherein, after the predetermined learning time interval has elapsed, the electronic control and command unit is configured to cyclically measure the value indicative of the distance between the tool and the remote device by processing signals exchanged between the first wireless transceiver device and the second wireless transceiver device, and to bring or keep the landscaping tool in the inactive condition when said value indicative of the measured distance falls outside the operating range.

It is thereby possible to make the apparatus more precise and therefore safer, as these features allow the equipment to be adapted to the user's needs. For example, these features may allow to define reduced distance ranges, e.g. with a delta of 1 or 2 m, which allow stricter and safer input of the automatic motor switching-off control, without affecting at the same time the usability of the tool.

According to an aspect of the invention, wherein the tool comprises a movable working element actuatable by the motor of the tool, and wherein the inactive condition is a condition wherein the movable working element is not actuated.

If the tool motor is an electric motor, the electronic control and command unit is operatively connected to said electric motor and may be configured to automatically switch off or keep the motor switched off when said value indicative of the measured distance is higher than said reference value.

The landscaping tool forming part of the apparatus subject of the invention is preferably at least one of a chainsaw, a brush cutter, a hedge trimmer, a lawnmower, a walking tractor and a pruner.

The remote device is at least one of a smartphone and a wearable item. This solution simplifies the installation of a software on the remote device, without having to produce a dedicated remote device.

According to another aspect of the invention, the first transceiver and the second transceiver may be of the Ultra-wide-band type. An accurate distance measurement is thereby ensured.

### BRIEF DESCRIPTION OF THE DRAWINGS

Further features and advantages of the invention will be more apparent after reading the following description provided by way of non-limiting example, with the aid of the accompanying drawings.

FIG. 1 is a schematic view of the apparatus according to the invention.

FIG. 2 is a schematic block view of the apparatus of FIG. 1.

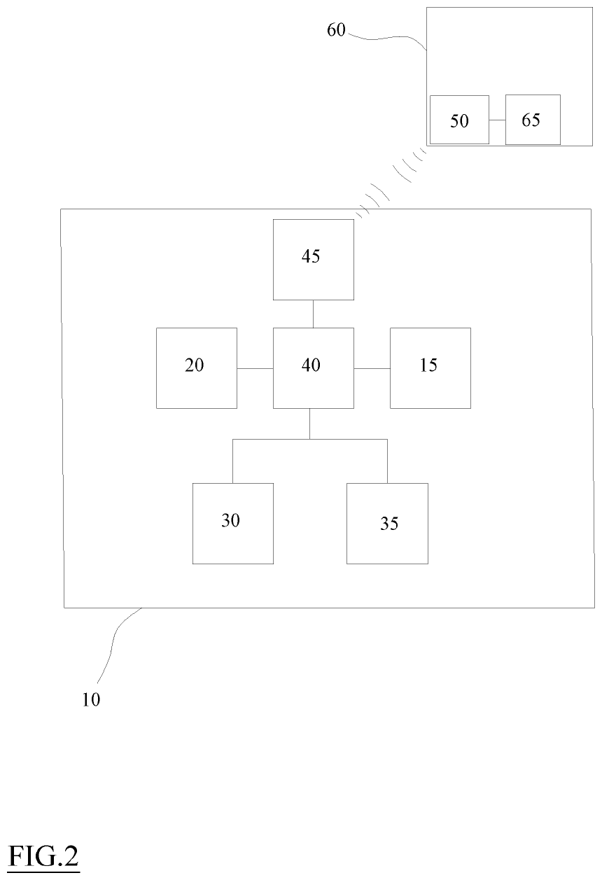

### BEST MODE TO IMPLEMENT THE INVENTION

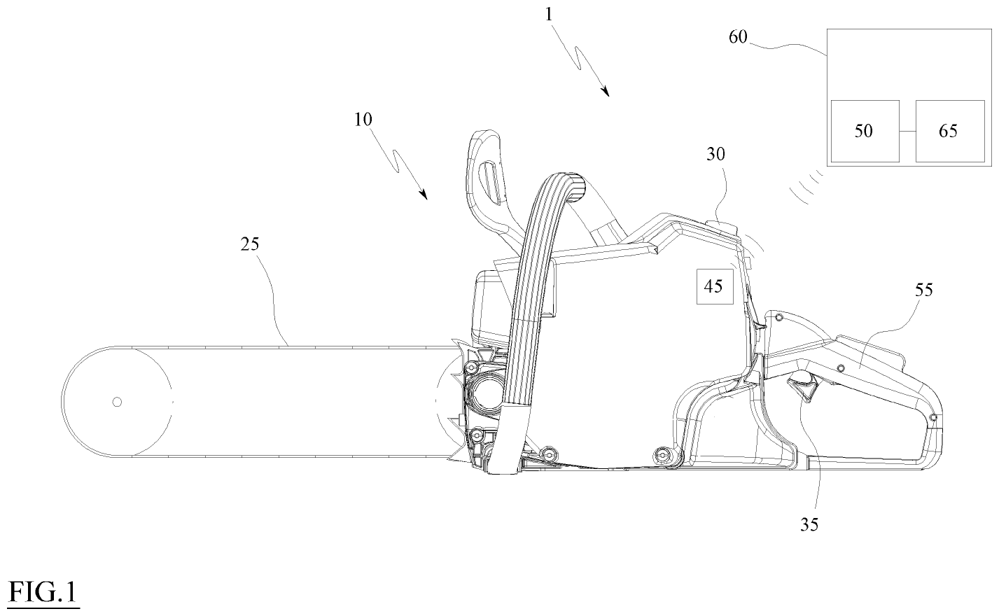

With particular reference to these FIG. 1 denotes a landscaping apparatus comprising a landscaping tool, such as a chainsaw, a brush cutter, a pruner, a lawnmower, a flail mower, a walking tractor (motor hoe, scarifier, etc.), a hedge trimmer, a sprayer or a blower.

In particular, the tool is of the type comprising a movable cutting element actuated by power generated by a motor of the tool itself, such as a chainsaw, a brush cutter, a pruner, a lawnmower, a flail mower, a walking tractor (motor hoe, scarifier, etc.) or a hedge trimmer.

For merely exemplary purposes a chainsaw 10 is shown in the Figures.

The tool 1 may comprise a motor 15, for example electric or endothermic. Preferably, the motor is electric, since one object of the present invention is to remedy the inherent excessive ease of switching on electrically-driven landscaping tools, i.e. landscaping tools actuated by an electric motor.

The motor 15 is powered by a power source 20, which may be a fuel tank in the case of an endothermic motor, or an electric energy source in the case of an electric motor. The source of electric energy may in turn be a battery housed in the tool itself or a cable connected to an electric energy distribution network.

Such a motor is in particular a motor for operating a movable working element of the tool itself (an element which enables to carry out a job for which the tool is designed). Such movable working element may be the movable cutting element, such as a chain with sharp teeth, a rotating wire or a plurality of parallel sharp teeth or rotating knives, or an impeller or fan adapted to put pressure on a fluid (usually air).

For example, in the case of the chainsaw, the brush cutter, the pruner, the lawnmower, the flail mower, the walking tractor and the hedge trimmer, the motor 15 actuates a movable cutting element (the chainsaw comprises the chain with sharp teeth, the brush cutter comprises the rotating wire, the pruner comprises the plurality of parallel sharp teeth, the lawnmower comprises the plurality of rotating knives, the flail mower comprises the plurality of rotating knives, the walking tractor comprises the plurality of rotating knives, the hedge trimmer comprises the plurality of parallel sharp teeth). The blower and sprayer comprise the impeller or fan. In the embodiment shown, the movable working element is a chain provided with sharp teeth 25.

The landscaping tool may comprise a user interface element 30, for example a push button, (fixed to a tool casing) to control the switching on of the tool. In addition or in alternative, the tool may comprise a user interface element 35, such as a trigger or selector, (fixed to a tool casing) to control (adjust) a movement of the movable working element, for example by controlling (adjusting) the motor torque delivered by the motor or controlling (adjusting) a maximum rotation speed of a drive shaft.

The landscaping tool further comprises an electronic control and command unit 40 configured at least to actuate the tool between an inactive condition and an active condition of the tool.

In particular, the user interface element 30 is operatively connected, e.g. galvanically connected (however, it is not excluded that it may be a wireless remote control device), to the electronic control and command unit 40, which is configured to bring the tool from a switched-off condition to a waiting-for-commands condition (and possibly also vice versa) based on the reception of a command given via the user interface element 30 (and possibly also via the user interface element 35).

The user interface element 35 is also operatively connected to the electronic control and command unit, e.g., galvanically, and the electronic control and command unit is configured to vary the motor torque (or maximum speed) delivered by the tool motor (by acting on the motor power supply) based on a signal given by the user via the user interface element 35 (e.g. increasing the pressure on the trigger or moving the selector, the motor torque delivered or the maximum speed of rotation are increased). Such torque variation may occur when the tool is in the waiting-for-commands condition.

The condition in which the tool is off is a condition wherein at least the user interface element 35 is disabled (and e.g. wherein the motor is off, i.e. not power supplied), the waiting-for-commands condition is a condition in which the user interface element 35 is enabled and, through it, it is possible to command the motor torque (or the maximum rotation speed) delivered by the motor (in such a condition the motor may be switched on in case it is endothermic or switched off in case the motor is electric). Such waiting-for-commands condition, which may be given via the user interface element 30, may be by-passed, as will become clearer hereinafter.

The inactive condition is a condition wherein the movable working element is not actuated (e.g. is stationary), preferably one wherein no driving force (generated by the motor of the tool itself) is transmitted to the working element.

For example, such a condition may also be a condition wherein the motor of the tool is switched off and therefore the working element is stationary. Alternatively, such an inactive condition may be a condition wherein the motor is switched off (i.e. not power supplied), the movable working element is consequently stationary, and wherein the user interface element (in particular at least the user interface element 35) is disabled (its actuation therefore does not allow the tool to be activated). Such disabling may for example be in the form of a configuration of the electronic control and command unit such that signals from the user interface element, in particular even only those from the user interface element 35, are ignored or by-passed by the electronic control and command unit 40.

The tool inactive condition corresponds to the tool switched-off condition when the motor is switched off and the user interface element 35 is disabled.

In the case of the endothermic motor, the inactive condition may be obtained by bringing or keeping in a decoupled position a coupling (if present), for example clutch or friction clutch, which allows to couple and decouple the tool motor to the movable working element. In addition or in alternative the inactive condition may be obtained by switching off, or keeping switched off, the endothermic motor (e.g. by preventing a spark plug adapted to generate a spark in a motor combustion chamber from being powered). Still in addition to or as an alternative to these aspects, the inactive condition in the endothermic motor may provide disabling at least one of the two interface elements, in particular by disabling at least the user interface element 35. With this last option, it is impossible for the user to actuate the movable working element even though the motor may be in an active/stand-by condition (endothermic motor idling) wherein it is ready for use.

In the case of the electric motor, the inactive condition may be obtained by switching off or keeping the electric motor switched off, e.g. by cutting off the electric power supply to the motor or keeping it non-powered. It should be noted that a switched-off electric motor means that it does not generate a driving torque or that the rotation speed is zero.

In addition to or as an alternative to switching off the motor, the inactive condition in the electric motor may provide disabling at least one of the two interface elements, in particular it is provided to disable at least (or only) the user interface element 35. With this last option, it is impossible for the user to actuate the movable working element even though the motor may be in an active/stand-by condition wherein it is ready for use. In the case of the endothermic motor, the active condition corresponds to a condition wherein the motor is switched on (combustion takes place in the combustion chamber) and wherein the coupling (if present) is in a coupling position. Also in such active condition the interface element, in particular the user interface element 35, is enabled.

Still in the case of the endothermic motor, the active condition corresponds to the waiting-for-commands condition when the endothermic motor is switched on at its minimum rotation regime, the coupling (if present) is in the decoupled position, and the user interface element 35 is enabled.

In the case of the electric motor, the active condition corresponds to a condition wherein the electric motor is electrically powered and one drive shaft thereof rotates. In alternative or in addition, the active condition in the case of an electric motor corresponds to a condition wherein the drive shaft does not rotate (the electric motor is switched off) and may be rotated by actuating the user interface element, for example the user interface element 35.

Still in the case of the electric motor, the active condition corresponds to the waiting-for-commands condition when the endothermic motor is switched off (not powered so that its drive shaft can rotate) and the user interface element 35 is enabled.

The electronic control and command unit is then operatively connected at least to the motor to control its power supply (and/or to the coupling to control its position between coupled and uncoupled, if present) and to the user interface element (or user interface elements 30 and 35) to monitor signals from the user interface element. In addition, the electronic control and command unit 40 may be configured to actuate the motor (and the coupling, if present) based on the user interface element (user interface element 35) in if in the active condition, and may be configured to ignore/by-pass such signals if in the inactive condition.

In a preferred embodiment, the electronic control and command unit 40 is configured to switch the motor (both electric and endothermic) on and off to allow the switching on and switching off thereof.

The landscaping tool further comprises a transceiver 45 of the wireless type operatively connected to the electronic control and command unit 40, e.g. galvanically connected to it.

The transceiver 45 is, for example, attached to a portion of the tool itself, in particular it is contained within a tool protective casing and fixed to a portion of said protective casing.

The transceiver 45 may be placed in different positions on the tool, preferably it is placed near a handle 5 of the tool itself or near the motor.

The transceiver 45 is of a type supporting the Ultra-wide-band (UWB) communication protocol. Such communication protocol comprises signals whose bandwidth is very wide in absolute value (at least 500 MHZ) or in relative value (at least 20% of the centre frequency).

The apparatus further comprises a portable remote device 60 provided with its own electronic control and command unit 65 and a transceiver 50, of the wireless type, operatively connected, e.g. galvanically, to the electronic control and command unit 65. The transceiver 50 is of the type capable of supporting the Ultra-wide-band (UWB) communication protocol, and the electronic control and command unit 65 and the electronic control and command unit 40 are configured to communicate with each other via the transceiver 45 and the transceiver 50, for example by means of software installed on memory units respectively connected to the electronic control and command unit 65 and the electronic control and command unit 40.

The portable remote device may, for example, be a smartphone or smartband provided with said transceiver 50 (and on which a software configured to communicate with the tool electronic control and command unit 40 is run) or a specially made device, for example wearable.

The apparatus 1 comprises a first wireless transceiver operatively connected to the electronic control and command unit 40 of the tool and a second wireless transceiver operatively connected to the electronic control and command unit 65 of the portable remote device.

In the embodiment shown, the first wireless transceiver corresponds to transceiver 45 and the second transceiver corresponds to transceiver 50.

The electronic control and command unit 40 of the tool is configured to cyclically (e.g. every 1-5 seconds) measure a value indicative of a distance between the tool 10 and the portable remote device 60 (only) by processing (predetermined) (radio) signals exchanged between the transceiver 45 and the transceiver 50.

In particular, by processing (predetermined) (radio) signals exchanged between the transceiver 45 and the transceiver 50 the electronic control and command unit 40 is able to measure an indicative value of a (minimum) distance between the transceiver 45 and the transceiver 50.

The electronic control and command unit 40 may also be configured to calculate the distance value on the basis of the value indicative of the distance.

In addition, the electronic control and command unit 65 may equally monitor the value of the parameter indicative of the distance (and possibly calculate the value of the distance based on the indicative value).

The person skilled in the art is familiar with various methods of measuring the value indicative of a distance using two wireless transceivers, therefore some of them will be hereinafter briefly introduced for merely exemplary purposes. A known method is the so-called Round-Trip Time (RTT), wherein a master device, for example consisting of the electronic control and command unit 40 and the transceiver 45, is able to measure the time of flight of a wireless signal propagating in a round-trip path to a slave device, for example consisting of the electronic control and command unit 65 and the transceiver 50. Other methods are One-way-ranging, Two-way ranging, which are based on internal clocks of the master device and the slave device, and methods based on measuring the intensity of the signal strength.

The electronic control and command unit 40 is also configured to (cyclically) compare said value indicative of the measured distance (or the value of the calculated distance) with a predetermined value indicative of a (preset) maximum distance (or with a predetermined value of a maximum distance). The maximum distance may, for example, be around 10 m.

Based on said comparison, when said value indicative of the measured distance is greater than said predetermined value indicative of the maximum distance, the electronic control and command unit 40 is configured to automatically:
bring the tool in the inactive condition, if (immediately before the comparison) the tool was in the active condition, and/or
keep the tool in the inactive condition, if (immediately before the comparison) the tool was in the inactive condition.

Furthermore, the electronic control and command unit 40, when said value indicative of the measured distance is greater than said predetermined value indicative of the maximum distance, may be configured to de-activate the user interface element 30 (and the user interface element 35). Such de-activation means that the signals to the electronic control and command unit 40 sent via the user interface element 30 (and the user interface element 35) are ignored or by-passed by the electronic control and command unit 40, so that said signals do not allow the tool to be brought into the active condition.

Such configurations of the electronic control and command unit 40 are also possible in the case where it is not possible to measure the value indicative of the measured distance. In particular, in alternative or in addition, the electronic control and command unit 40 may be configured, when it is not possible to measure the value indicative of the measured distance, to:
bring the tool in the inactive condition, if (immediately before the comparison) the tool was in the active condition, and/or
keep the tool in the inactive condition, if (immediately before the comparison) the tool was in the inactive condition.

Such impossibility to measure the value indicative of the measured distance corresponds to a condition wherein the second transceiver is switched off or is outside the range of the first transceiver.

Hereinafter, when reference is made to a configuration occurring when the value indicative of the measured distance is lower than said predetermined value indicative of the maximum distance, it should always be included that, in alternative or in addition, the same configuration may occur when it is not possible to measure the value indicative of the measured distance.

Furthermore, the electronic control and command unit may be configured, when the value indicative of the measured distance is lower than said predetermined value indicative of the maximum distance, to automatically:
bring the tool into the active condition, if (immediately before the comparison) the tool was in the inactive condition, and/or
keep the tool in the active condition, if (immediately before the comparison) the tool was in the active condition.

In such a case, when the value indicative of the measured distance is lower than said predetermined value indicative of the maximum distance, the electronic control and command unit 40 is further configured to automatically enable the user interface element 30 (and the user interface element 35). Such enablement means that the signals to the electronic control and command unit 40 sent via the user interface element 30 (and the user interface element 35) are processed by the electronic control and command unit 40 to enable the changes of state for which the interface elements are designed (respectively, switching the tool between the switched-off condition and the waiting-for-commands condition and adjusting the driving torque or the maximum rotation speed delivered by the tool motor).

It may be provided that this automatic configuration of the electronic control and command unit 40 adapted to bring the tool into the active condition, in case it was previously in the inactive condition, when the value indicative of the measured distance is lower than said predetermined value indicative of the maximum distance, may only be implemented if, in a predetermined previous time interval, the value indicative of the measured distance was lower than the value indicative of the maximum distance (or even only when it is possible to detect the presence of the second transceiver) and at the same time the user interface element 30 had been actuated to bring the tool from the inactive state to the active state (or rather from the switched-off state to the waiting-for-commands state). This may allow to prevent the tool from activating automatically.

In addition, when the electronic control and command unit 40 is configured according to one of the above set forth distance-related conditions, the electronic control and command unit 40 is configured to allow the tool to be switched from the switched-off condition to the waiting-for-commands condition only when the value indicative of the measured distance is lower than said predetermined value indicative of the maximum distance (or even only when it is possible to detect the presence of the second transceiver) and simultaneously the user interface element 30 is actuated (e.g. switched to bring the tool from the switched-off condition to the waiting-for-commands condition).

It is not excluded that in an alternative embodiment, when the value indicative of the measured distance is lower than said predetermined value indicative of the maximum distance, the electronic control and command unit 40 may additionally be configured to bring the tool into the active condition only upon reception of a signal sent via the user interface element 30 (and/or the user interface element 35). So in this case, the activation would not occur automatically, which would make the tool more uncomfortable to use, slower, but further safer.

In order to allow the tool to be switched on, or first switched on when the user starts to use the tool, the electronic control and command unit 40 may further be configured, when the value indicative of the measured distance is lower than said predetermined value indicative of the maximum distance, to automatically enable the user interface element 35, after actuating the user interface element 30, if before the actuation of the user interface element 30, the tool was in the switched-off condition.

In addition, the electronic control and command unit 40 may be configured (when the tool is in the switched-off condition, e.g. for at least a predetermined minimum time) to start monitoring the distance (and search for the transceiver of the remote device) after actuating the user interface element 30. As long as the electronic control and command unit 40 does not detect the portable remote device within the maximum distance, it is configured to perform at least one of the following operations:
disabling the user interface element 35,
switching the motor off or keeping it switched off,
decoupling or keeping the coupling in a decoupled position (in the case of the endothermic motor).

In case the tool is provided with an electric motor, the electronic control and command unit 40 may be configured, when said value indicative of the measured distance is greater than said value indicative of the maximum distance, to automatically:
switch off the electric motor, if (immediately before the comparison) the electric motor was switched on, and/or
keep the electric motor switched off, if (immediately before the comparison) the electric motor was switched off, and/or
switch the electric motor off and disable at least one of the user interface element 30 and the user interface element 35 (in particular at least or only the user interface element 35), if (immediately before the comparison) the electric motor was switched on and the interface element was enabled, and/or
keep the electric motor switched off and disable at least one of the user interface element 30 and the user interface element 35 (in particular at least or only the user interface element 35), if (immediately before the comparison) the electric motor was switched off and the user interface element was enabled, and/or
disable at least one of the user interface element 30 and the user interface element 35 (in particular at least or only the user interface element 35), if (immediately before the comparison) the user interface element was enabled, and/or
keep the user interface element 30 or 35, or user interface elements 30 and 35, disabled if (immediately before the comparison) the user interface element between 30 and 35 was disabled, or if all the interface elements were disabled.

When the value indicative of the measured distance is lower than said predetermined value of the maximum distance, the electronic control and command unit 40 may be additionally configured to automatically:
keep the electric motor switched off and enable at least one of the user interface element 30 and the user interface element 35 (in particular at least or only the user interface element 35), if (immediately before the comparison) the electric motor was switched off, and/or
keep the electric motor switched on and keep the user interface element 35 enabled, if (immediately before the comparison) the user interface element 35 was enabled and the electric motor was switched on.

In case the tool is provided with an endothermic motor, when the value indicative of the measured distance is greater than the value indicative of the maximum distance, the electronic control and command unit 40 may be configured to automatically:
in case (immediately before the comparison) the endothermic motor was switched on:
   switch off the endothermic motor, and/or
   bring the coupling into a decoupled position, and/or
   keep the endothermic motor switched on (at idle speed) and disable the user interface element 35,

In addition or in alternative, the electronic control and command unit is configured, when the value indicative of the measured distance is greater than said value indicative of the maximum distance, to automatically:
keep the endothermic motor switched off, if (immediately before the comparison) the endothermic motor was switched off, and/or
keep the endothermic motor switched on (at idle speed) and keep the user interface element 35 disabled if (immediately before the comparison) the endothermic motor was switched on (at idle speed) and the user interface element 35 was disabled, and/or
keep the coupling in the decoupled position if (immediately before the comparison) the coupling was in the decoupled position.

For both the electric motor and the endothermic motor, the inactive condition may provide inhibiting the user interface elements, in particular the user interface element 35. In all the embodiments, the electronic control and command unit 40 is configured to always leave the user interface element 30 (and for example also the interface element y) enabled when the distance is lower than the predetermined maximum value.

In all described embodiments, the electronic control and command unit 40 may also be configured to automatically bring or keep the landscaping tool in an active condition when the value indicative of the measured distance is lower than the predetermined value indicative of the maximum distance, if within a predetermined time interval from a time of measurement of the parameter indicative of the distance, the electronic control and command unit 40 receives a predetermined authorisation signal containing a specific identification code (unique, different for each portable remote device) sent by the portable remote device 60 (thus by the electronic control and command unit 65) via the transceiver 50.

Such an identification code may be indicative of a specific identity, such as the user of the tool or of the portable remote device.

Furthermore, the electronic control and command unit 40 may be configured to compare the identification code sent by the portable remote device 60 via the transceiver 50 with a plurality of preset codes stored in a memory unit operatively connected to the electronic control and command unit 40, and to automatically bring or keep the landscaping tool in an active condition when the value indicative of the measured distance is lower than the predetermined value indicative of the maximum distance, if within a predetermined time interval from a time of measuring the parameter indicative of the distance, the electronic control and command unit 40 receives the predetermined authorization signal containing the specific identification code (unique, different for each portable remote device) sent by the portable remote device 60 via the transceiver 50 and said detected identification code corresponds to one of the codes present in the memory unit. Even the first switching-on step may provide the aforesaid recognition of the identification code in order to bring the tool into the active or waiting-for-commands condition, in addition to the conditions already introduced above.

In addition to the configurations presented so far, the electronic control and command unit 40 may be configured to perform a learning step, which may for example be selected (actuated) by the tool user or by means of an interface element pre-arranged on the tool or by means of the portable remote device.

When the electronic control and command unit 40 performs the learning step, for a predetermined learning time interval the electronic control and command unit cyclically monitors the value indicative of the distance between the tool and the remote device (i.e., between transceiver 45 and transceiver 50) and stores the detected values in a memory unit. After the learning time interval has elapsed, it calculates an operating range of values indicative of the distance.

Such operating range may be obtained by calculating an average value of the measured values and then applying a safety coefficient to it. For example, by multiplying the calculated average value by the safety coefficient and then adding the result of the multiplication between the average value and the safety coefficient to the average value, a value of the upper end of the operating range is obtained. By subtracting the result of multiplying the average value and the safety coefficient from the average value, a value of the lower end of the operating range is obtained.

In alternative, a selection range of distance values at which the tool and the remote device are located for 80% of the learning time interval may be used, with the minimum value of the selection range being the lower end of the operating range and the maximum value of the selection range being the upper end of the operating range.

Having calculated the operating range of the values indicative of the distance, the electronic control and command unit is configured to cyclically measure the value indicative of the distance between the tool and the remote device and to automatically bring or keep the landscaping tool in the inactive condition when said value indicative of the measured distance falls outside the operating range.

Therefore, all the configurations described above when the value is greater than the maximum distance apply to when the indicative value falls outside the operating range. Similarly, all of the above configurations when the value is lower than the maximum distance apply to when the value falls within the operating range

The operation of the apparatus according to the invention is as follows.

When the user wants to use the tool, he must carry the portable remote device with him so that the distance between the tool and the portable remote device is lower than value of the maximum distance. At that point, the electronic control and command unit 40 allows the tool to switch from the inactive condition to the active condition, preferably after the actuation of the user interface element 30.

After these operations, the user is free to use the tool remaining within the distance radius given by the maximum distance, in case he moves away from the tool beyond the maximum distance, when the electronic control and command unit of the tool detects that the remote portable device is too far away (or no longer detects the distance), it automatically switches the tool to the inactive condition. In this condition, the movable working element of the tool is not actuated and cannot be actuated, the actuation of the user interface elements 30 and 35 does not allow the movable working element to be actuated.

As long as the electronic control and command unit of the tool, in its cyclical monitoring, detects a distance greater than the maximum distance or does not detect at all the remote portable device, it keeps

It may be provided that, after a preset time interval from the last instant wherein the electronic control and command unit of the tool has detected the portable remote device outside the maximum distance or has not detected it, the tool electronic control and command unit is configured to stop the detection in order to save energy.

The invention thus conceived is susceptible to several modifications and variations, all falling within the scope of the inventive concept.

Moreover, all details can be replaced by other technically equivalent elements. In practice, the materials used, as well as the contingent shapes and sizes, may be whatever according to the requirements without for this reason departing from the scope of protection of the following claims. cm 1. A landscaping apparatus comprising:
a landscaping tool of the motor-driven type provided with an electronic control and command unit,
a portable remote device,
a first wireless transceiver operatively connected to the electronic control and command unit the landscaping tool,
a second wireless transceiver associated with the portable remote device,
wherein the electronic control and command unit is configured to cyclically measure a value indicative of a distance between the tool and the portable remote device by processing signals exchanged between the first wireless transceiver and the second wireless transceiver,
and wherein the electronic control and command unit is configured to cyclically compare said value indicative of the measured distance with a predetermined value indicative of a maximum distance and to automatically bring or keep the tool in an inactive condition when said value indicative of the measured distance is higher than said reference value and/or when it is not possible to measure the value indicative of the measured distance.

2. The apparatus according to claim 1, wherein the predetermined value indicative of the maximum distance is equal to a maximum distance of 10 m.

3. The apparatus according to claim 1, wherein the electronic control and command unit is also configured to automatically bring or keep the landscaping tool in an active condition when the value indicative of the measured distance is lower than the predetermined value indicative of the maximum distance.

4. The apparatus according to claim 3, wherein the electronic control and command unit is also configured to automatically bring or keep the landscaping tool in an active condition when the value indicative of the measured distance is lower than the predetermined value indicative of the maximum distance, if, within a predetermined time interval from a time of measuring the parameter indicative of the distance, the electronic control and command unit receives a predetermined authorization signal containing a specific identification code sent by the remote portable device via the second wireless transceiver.

5. The apparatus according to claim 1, wherein the electronic control and command unit may be configured to perform a learning step during which, for a predetermined learning time interval the electronic control and command unit cyclically monitors the value indicative of the distance between the tool and the remote portable device, stores the detected values in a memory unit and on the basis of the values indicative of the distance stored during the learning time interval defines an operating range of values indicative of the distance,
and wherein, after the predetermined learning time interval has elapsed, the electronic control and command unit is configured to cyclically measure the value indicative of the distance between the tool and the remote device by processing signals exchanged between the first wireless transceiver device and the second wireless transceiver device, and to bring or keep the landscaping tool in the inactive condition when said value indicative of the measured distance falls outside the operating range.

6. The apparatus according to claim 1, wherein the tool comprises a movable working element actuatable by a motor of the tool itself, and wherein the inactive condition is a condition wherein the movable working element is not actuated.

7. The apparatus according to claim 6, wherein the motor of the tool is an electric motor, and wherein the electronic control and command unit is operatively connected to said electric motor and is configured to automatically switch off or keep the motor switched off when said value indicative of the measured distance is greater than said reference value.

8. The apparatus according to claim 1, wherein the landscaping tool is at least one of a chainsaw, a brush cutter, a hedge trimmer, a lawnmower, a walking tractor and a pruner.

9. The apparatus according to claim 1, wherein the portable remote device is at least one of a smartphone and a wearable item.

10. The apparatus according to claim 1, wherein the first transceiver and the second transceiver are of the Ultra-wide-band type.

11. The apparatus according to claim 1, wherein the electronic control and command unit is adapted to bring the tool into the active condition, in case it was previously in the inactive condition, when the value indicative of the measured distance is lower than said predetermined value indicative of the maximum distance, may only be implemented if, in a predetermined previous time interval, the value indicative of the measured distance was lower than the value indicative of the maximum distance and at the same time the user interface element had been actuated to bring the tool from the inactive state to the active state.

12. The apparatus according to claim 1, wherein the electronic control and command unit is configured to allow the tool to be switched from the switched-off condition to the waiting-for-commands condition only when the value indicative of the measured distance is lower than said predetermined value indicative of the maximum distance and simultaneously the user interface element is actuated.

13. The apparatus according to claim 1, wherein the electronic control and command unit may additionally be configured to bring the tool into the active condition only upon reception of a signal sent via the user interface element and/or the user interface element.
